(19) United States
(12) Patent Application Publication
(10) Pub. No.: US 2019/0374040 A1
(43) Pub. Date: Dec. 12, 2019

(54) CREASE RESISTANT SHIPPING MATTRESS AND MATTRESS KIT

(71) Applicant: BUNDLE OF DREAMS, LIMITED LIABILITY COMPANY, Brooklyn, NY (US)

(72) Inventors: Kyle Stuart Minarsky, New York, NY (US); Paul Minarsky, New York, NY (US); Richard Weinberg, Demarest, NJ (US)

(73) Assignee: BUNDLE OF DREAMS, LIMITED LIABILITY COMPANY, Brooklyn, NY (US)

(21) Appl. No.: 16/004,500

(22) Filed: Jun. 11, 2018

(51) Int. Cl. A47C 27/00; B68G 7/10

(52) U.S. Cl. CPC A47C 27/001; B68G 7/10

(57) ABSTRACT

A shipping mattress structured to resist shipping creases including a plurality of core layers with stacked individual layers. The individual layers may each include at least one surface with at least one surface corner and one surface end. Furthermore, at least one of the surface corner and surface end of each individual layer may be secured to at least one of the surface corner and surface end of another individual layer.

### FIELD OF THE INVENTION

The present invention is related to mattresses suitable for shipping and, more particularly, to a crease-resistant shipping mattress, as well as a mattress kit.

### BACKGROUND

Transporting mattresses has been a long-standing problem. The overall size and shape of a mattress combined with its construction and materials tend to make transportation difficult. Furthermore, mattresses are bulky and consume a great deal of surface area. As a result, oftentimes mattresses are transported flat. Recent solutions have included the transportation of mattresses within a shipping container. However, these solutions fail to insure the integrity of the mattress because of the material and method employed. As shown in FIG. 1, most solutions include constructing a mattress 101 from foam and rolling the mattress to fit inside a box. Boxing and transporting mattresses in this fashion causes permanent or enduring creases 102 in the mattress 101 when unpackaged. Therefore, there exists a need in the art for a mattress constructed for shipping that maintains its integrity when shipped and unpacked.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a crease-resistant shipping mattress and a mattress kit. More specifically, an embodiment of the invention provides for a mattress structured to resist shipping creases including a plurality of core layers with stacked individual layers. The individual layers may each include at least one surface with at least one surface corner and one surface end. Furthermore, at least one of the surface corner and surface end of each individual layer may be secured to at least one of the surface corner and surface end of another individual layer.

In this embodiment, each individual layer may include a density. Furthermore, the plurality of core layers may be defined by a first stacked end and a second stacked end. The density of an individual layer at the first stacked end may be higher than the density of the individual layer at the second stacked end. Additionally, the plurality of core layers may include a first individual layer and a second individual layer. The first individual layer may have a higher density than the second individual layer. The first individual layer may be firmer than the second individual layer.

The surface corners of one individual layer may be secured to the surface corners of another individual layer by an adhesive. Likewise, the surface corners of one individual layer may be secured to the surface corners of another individual layer by a singed bond. The singed bond may be positioned between one of the surface corner material and a metallic matter attached to the surface corner material. The metallic matter may be one of aluminum and brass and the singed bond may be structured as one of a radio frequency weld, a hot wedge weld, and hot air weld. In one embodiment adhesive may be applied along one of opposing longitudinal surface ends and latitudinal surface ends.

Another embodiment may present a plurality of core layers including stacked individual layers whereby the individual layers each have at least one surface circumscribed by surface edges. Furthermore, each surface may include a surface perimeter defined by an area beginning at the surface edges and extending twelve inches distally toward a center portion of the surface. The stacked individual layers may be secured to one another at the surface perimeter by symmetrically applied perimeter adhesive along the surface perimeter. Additionally, perimeter adhesive may be one of anaerobic, cyanoacrylate, toughened acrylic, epoxy, polyurethane, silicone, phenolic, polyimide, hot melt, plastisol, and polyvinyl acetate.

In this embodiment at least one individual layer within the plurality of core layers may be secured to another individual layer by a singed bond at the surface edges. Furthermore, each individual layer may include a surface end. At least one individual layer's surface end may further be secured to another individual layer's surface end by a series of hooks on one individual layer surface end interlocking with a series of loops on the other individual layer's surface end. Additionally, each individual layer within the plurality of core layers may further be secured within a wrapper and the wrapper may further be secured within a mattress casing.

Another embodiment of the invention may include a mattress kit structured to resist shipping creases including a box sized to accommodate at least one of a rolled mattress and folded mattress. It may include a mattress with a plurality of core layers including stacked individual layers. The mattress may also include a wrapper structured to encapsulate the plurality of core layers and a mattress casing configured to encapsulate the wrapper. In this embodiment each individual layer may range from a higher density individual layer at a first stacked end of the plurality of core layers to a lower density individual layer at a second stacked end of the plurality of core layers. The mattress may be structured to fit inside the box when the mattress is one of rolled and folded, defined as a compressed mattress. The compressed mattress may be structured with lower density individual layers forming the inside of the compressed mattress and higher density individual layers forming the outside of the compressed mattress.

In some embodiments the individual layers may include surface ends and the surface ends between individual layers may be secured to each other by at least one of adhesive, a series of hooks and loops, and a singed bond. Furthermore, the individual layers may include surface corners and at least one surface of each individual layer within the plurality of core layers may be secured at a surface corner to at least one surface corner of another individual layer. Additionally, an individual layer's surface corner may be secured to another individual layer's surface corner by singed bond or adhesive. Another embodiment may include at least one individual layer's surface corner secured to another individual layer's surface corner by a segment of hooks on one individual layer's surface corner and a segment of loops on another individual layer's surface corner.

### BRIEF DESCRIPTION OF THE DRAWINGS

FIG. 1 is a perspective view of a mattress found in the prior art.

FIG. 2 is a perspective view of a shipping mattress in accordance with an embodiment of the invention.

FIG. 3 is a perspective view of an embodiment of the shipping mattress illustrated in FIG. 2 showing inner core layers with a top layer lifted.

FIG. 4 is a perspective view of another embodiment of the shipping mattress illustrated in FIG. 2 showing inner core layers with a top layer lifted.

FIG. 5 is an exploded view of an embodiment of the shipping mattress illustrated in FIG. 2 showing inner core layers being separated.

FIG. 6 is an exploded view of another embodiment of the shipping mattress illustrated in FIG. 2 showing inner core layers being separated.

FIG. 7 is a perspective view of an embodiment of the shipping mattress illustrated in FIG. 2 showing inner core layers and being encased in a wrapper.

FIG. 8 is a perspective and environmental view of an embodiment of the shipping mattress illustrated in FIG. 2 with singed corners.

FIG. 9 is a perspective view of another embodiment of the shipping mattress illustrated in FIG. 2 showing inner core layers with a top layer lifted.

FIG. 10 is a perspective view of another embodiment of the shipping mattress illustrated in FIG. 2 showing inner core layers with a top layer lifted.

FIG. 11a is a perspective view of an embodiment of the shipping mattress illustrated in FIG. 2 being rolled.

FIG. 11b is a perspective view of a shipping mattress kit according to the present invention including a box and rolled shipping mattress.

FIG. 12a is a perspective view of an embodiment of the shipping mattress illustrated in FIG. 2 being folded.

FIG. 12b is a perspective view of a shipping mattress kit according to the present invention including a box and folded mattress.

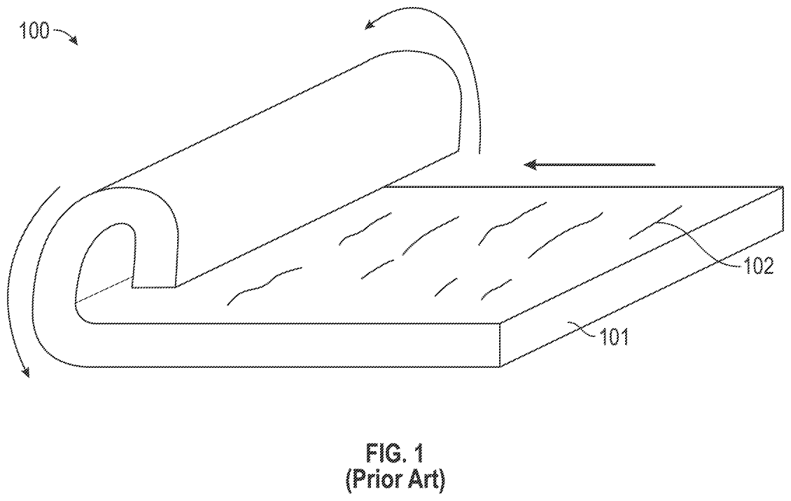

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure, Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a crease-resistant mattress constructed for packaging and shipping.

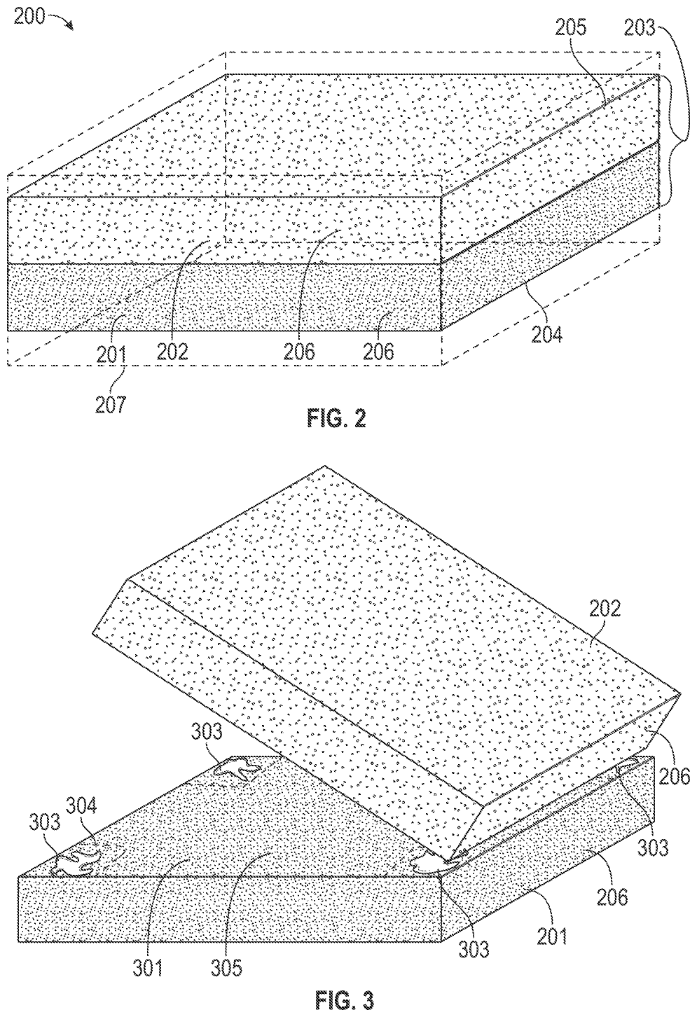

Referring to FIG. 2, an embodiment of the invention is shown illustrating a shipping mattress 200 that may include a plurality of core layers 203. The plurality of core layers 203 may include stacked individual layers 206 ranging from a first stacked end 204 to a second stacked end 205. An individual layer 206 at the first stacked end 204 may be a higher density individual layer 206, defined as a hard layer 201. An individual layer 206 at the second stacked end 205 may be a lower density individual layer 206, defined as a soft layer 202. A person skilled in the art will recognize that individual layers may be constructed from a variety of material. However, polyester may be the preferred material for construction of the plurality of core layers 203. More specifically, in the preferred embodiment, densified polyester is used for the plurality of core layers 203 instead of foam. Using densified polyester may provide the comfort provided by polyester, while ensuring the creaseless integrity of the shipping mattress 200 when the below method of construction is employed.

By way of non-limiting example, FIG. 2 shows the plurality of core layers 203 including two individual layers 206. However, those skilled in the art will appreciate that the plurality of core layers 203 may include more individual layers 206. The hard layers 201 may be positioned toward the first stacked end 204 and the soft layers 206 may be positioned toward the second stacked end 205. The shipping mattress 200 may also include a mattress casing 207 that may enclose the plurality of core layers 203 and form the mattress exterior. The mattress casing 207 may, for example, be a plastic material, a cloth material, a paper material, or any other type of material as may be understood by those skilled in the art suitable for protecting the mattress during shipping.

FIG. 3 illustrates that the individual layers 206 may include a surface 301 of each individual layer 206 within the plurality of core layers 203 secured at a surface corner 304 to at least one surface corner 304 of another individual layer 206. In this embodiment, the surface corners 304 of the hard layer 201 are secured to the surface corners 304 of the soft layer 202 by a corner adhesive 303 applied only to the surface corners 304. The remaining area that does not include the surface corners 304 of the surfaces 301 do not include an adhesive. This area of a surface 301 that does not include corner adhesive 303 is defined as the bare surface area 305. Therefore, in this embodiment the material of one surface 301 of an individual layer 206 is in direct contact with the material of an adjacent surface 301 of an individual layer 206 at the bare surface area 305 of each respective individual layer 206. For purposes of this application, the adhesive may include anaerobic, cyanoacrylate, toughened acrylic, epoxy, polyurethane, silicone, phenolic, polyimide, hot melt, plastisol, and polyvinyl acetate, or any other adhesive that may be used to accomplish the goals, features and objectives of the present invention.

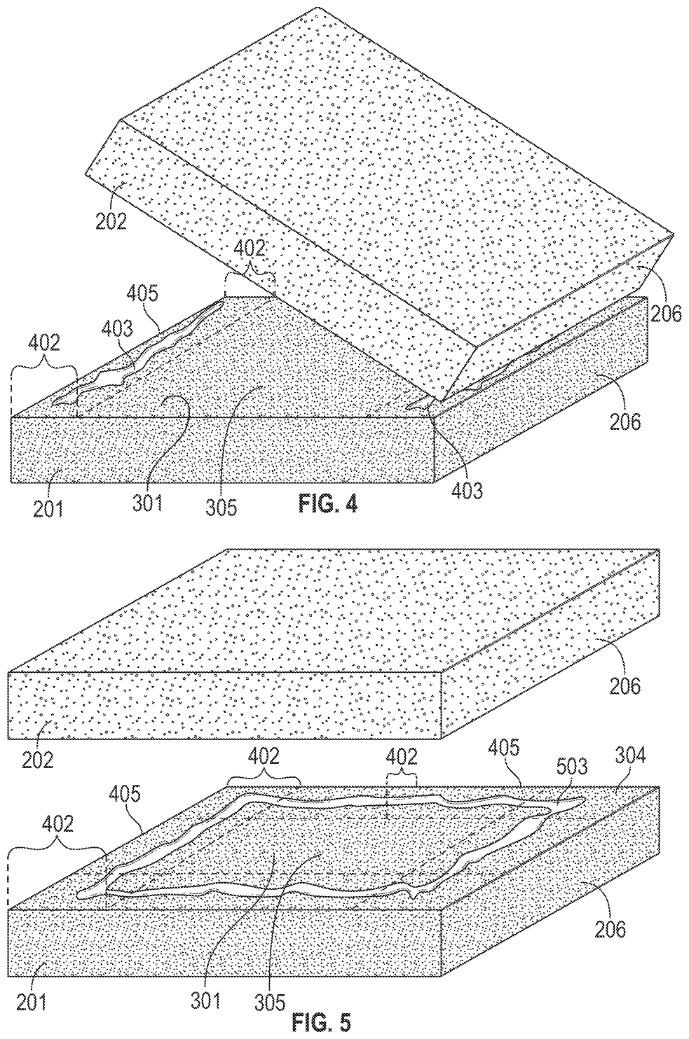

FIG. 4 illustrates an embodiment where the individual layers 206 may include a surface 301 secured at a surface end 402 to at least one surface end 402 of another individual layer 206. For purposes of this application, surface end 402 may be the region of a surface 301 ranging from its edge 405 to a small distance distal thereto. The small distance may be any distance between 0 and 12 inches from the edge 405. However, a person skilled in the art will recognize that the distance from the surface edge 405 may be larger while still accomplishing the goals, features and advantages according the present invention. In this embodiment, the surface ends 402 of the hard layer 201 are secured to the surface ends 402 of the soft layer 202 by a surface end adhesive 403 applied only to longitudinal surface ends 402. The remaining area that does not include the surface ends 402 of the surfaces 301 do not include an adhesive. This area of a surface 301 that does not include adhesive is the bare surface area 305. Therefore, in this embodiment the material of one surface 301 of an individual layer 206 is in direct contact with the material of an adjacent surface 301 of an individual layer 206 at the bare surface area 305 of each respective individual layer 206.

FIG. 5 illustrates an embodiment where the individual layers 206 may include a surface 301 secured at a perimeter to at least one surface perimeter of another individual layer 206. For purposes of this application, surface perimeter shall mean four surface ends 402 of a surface 301. In this embodiment, the surface perimeter of the hard layer 201 is secured to the surface perimeter of the soft layer 202 by a surface perimeter adhesive 503 applied only to the surface perimeter. In some embodiments, the surface perimeter adhesive 503 may be applied symmetrically around the surface perimeter. The remaining area that does not include the surface perimeter does not include an adhesive. This area of a surface 301 that does not include adhesive is the bare surface area 305. Therefore, in this embodiment the material of one surface 301 of an individual layer 206 is in direct contact with the material of an adjacent surface 301 of an individual layer 206 at the bare surface area 305 of each respective individual layer 206.

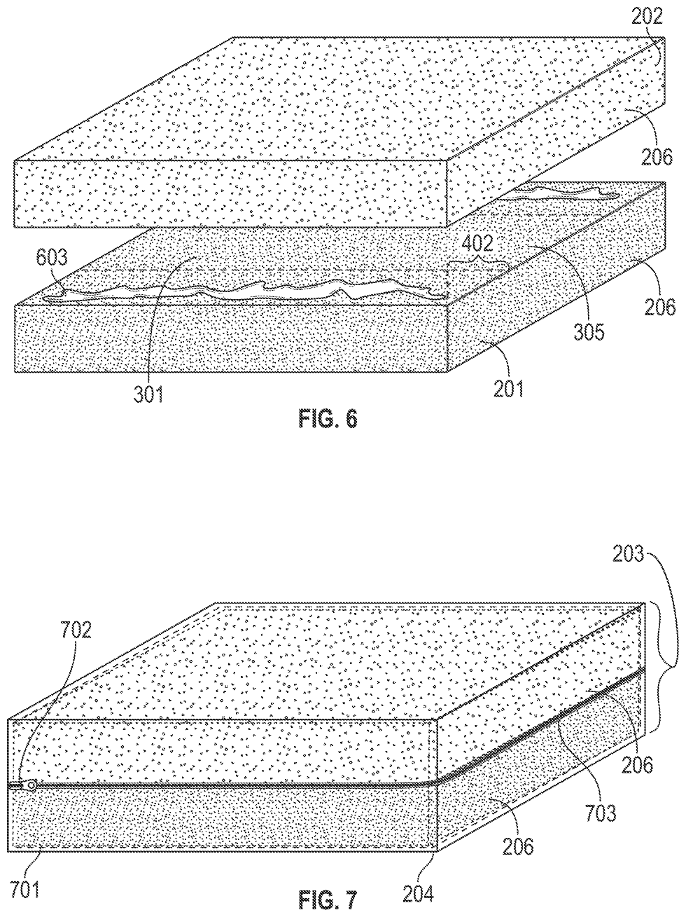

FIG. 6 illustrates an embodiment where the individual layers 206 may include a surface 301 secured at a surface end 402 to at least one surface end 402 of another individual layer 206, In this embodiment, the surface ends 402 of the hard layer 201 are secured to the surface ends 402 of the soft layer 202 by a surface end adhesive 603 applied only to latitudinal surface ends 402. The remaining area that does not include the surface ends 402 of the surfaces 301 do not include an adhesive. This area of a surface 301 that does not include adhesive is the bare surface area 305. Therefore, in this embodiment the material of one surface 301 of an individual layer 206 is in direct contact with the material of an adjacent surface 301 of an individual layer 206 at the bare surface area 305 of each respective individual layer 206.

FIG. 7 illustrates an embodiment where the individual layers 206 may be stacked together without the use of an adhesive between the individual layers 206. In this embodiment, a wrapper 701 may be used to contain the plurality of core layers 203 together, By way of non-limiting example, the wrapper 701 may be made of a variety of materials including, cotton, nylon, polyester, or any other type of textile. Plastic may also be used in some instances. In this embodiment, a zipper assembly with zipper teeth 703 and a zipper handle 702 may be used to secure the outside of the wrapper 701 to tightly hold the plurality of core layers 203 within the wrapper 701. However, a person skilled in the art will recognize that any number of means may be employed to secure the outside of the wrapper 701 including adhesive, stitching, buttons, or extra wrapper 701 material folded over itself. In this embodiment the entire material surface 301 of an individual layer 206 is in direct contact with the entire material of an adjacent surface 301 of an individual layer 206. Therefore, both surfaces 301 of the individual layers 206 in their entirety may be considered bare surface areas 305 of each respective individual layer 206. Furthermore, in this embodiment the wrapper 701 itself may be enclosed by the mattress casing 204, which may form the mattress exterior.

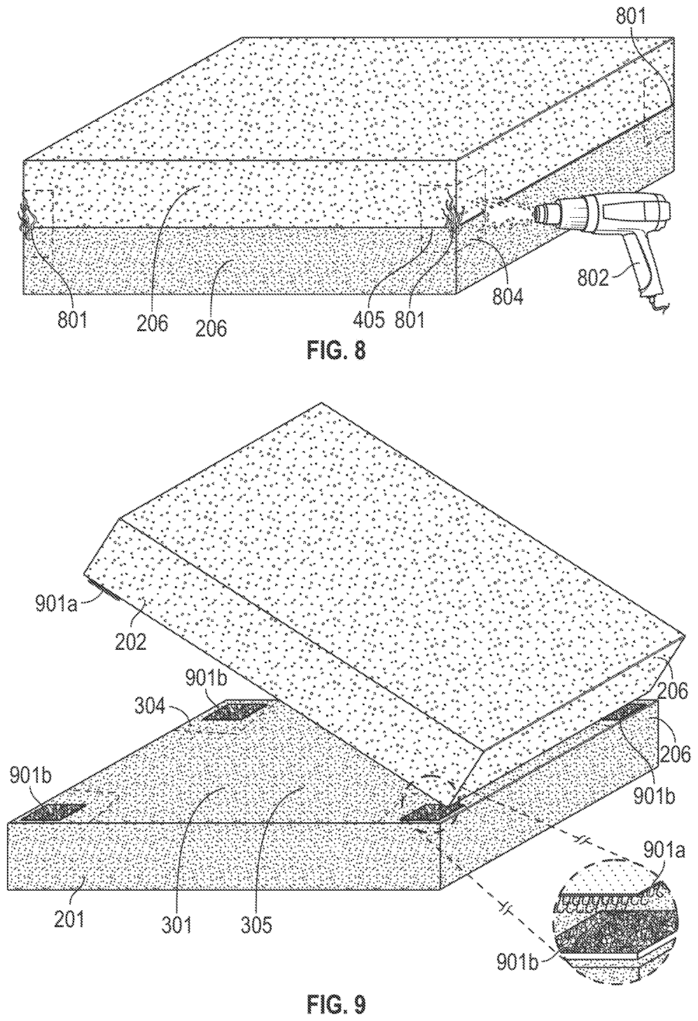

FIG. 8 illustrates an embodiment where the individual layers 206 may be secured by a singed bond 801 between an outside corner 804 of an individual layer 206 and another outside corner 804 of another individual layer 206, In this embodiment, an individual layer 206 may be stacked onto another individual layer 206 and a torch 802 may be used to heat outside corners 804 of each individual layer 206 to create the singed bond 801. In some embodiments the singe between a first individual layer 206 and a second individual layer 206 may include the entire perimeter along the edge 405. In other embodiments, the singed bond 801 may include a portion less than the entire perimeter along the edge 405. In some embodiments the surface corner 304 as depicted in FIG. 3 may be singed to create a singed bond 801 between the individual layers 206.

Other embodiments may include a singed bond 801 between the outside corner 804 or surface corner 304 material and a metallic matter attached to the outside corner 804 or surface corner 304 material. Another embodiment may include a singed bond 801 between a patch placed overtop of the outside corners 804 of the individual layers 206. In some embodiments the patch may be made of a metallic material, a polyester or fabric material, or a plastic material. However, those skilled in the art will appreciate that the patch may be made from a variety of different materials. Furthermore, by way of non-limiting example the patch may be secured to the individual layers 206 by way of an adhesive or stitching. By way of non-limiting example, the metallic matter may be aluminum or brass and the singed bond may be a radio frequency weld, a hot wedge weld, or hot air weld.

FIG. 9 illustrates that the individual layers 206 may include a surface 301 of each individual layer 206 removably secured at a surface corner 304 to at least one surface corner 304 of another individual layer 206 by segmented pairs of hooks 901a and loops 901b, i.e., hook and loop fasteners. In some embodiments the hooks 901a may be two millimeters or less in size and the loops 901b may be two millimeters or less in size. In other embodiments the hooks 901a and loops 901b may be larger.

In this embodiment, the loops 901b on surface corners 304 of the hard layer 201 are secured to hooks 901a on surface corners 304 of the soft layer 202. The hooks 901a and loops 901b are located only on the surface corners 304. The remaining area that does not include the surface corners 304 of the surfaces 301 do not include segmented pairs of hooks 901a and loops 901b. This area of a surface 301 that does not include hooks 901a and loops 901b is defined as the bare surface area 305. Therefore, in this embodiment the material of one surface 301 of an individual layer 206 is in direct contact with the material of an adjacent surface 301 of an individual layer 206 at the bare surface area 305 of each respective individual layer 206. In some embodiments the segmented pairs of hooks 901a and loops 901b may span the entire surface ends 402 of respective individual layers 206. Other embodiments may include the segmented pairs of hooks 901a and loops 901b spanning an entire surface perimeter of the respective individual layers 206. For purposes of this application, and as mentioned above, surface perimeter shall mean four surface ends 402 of a surface 301.

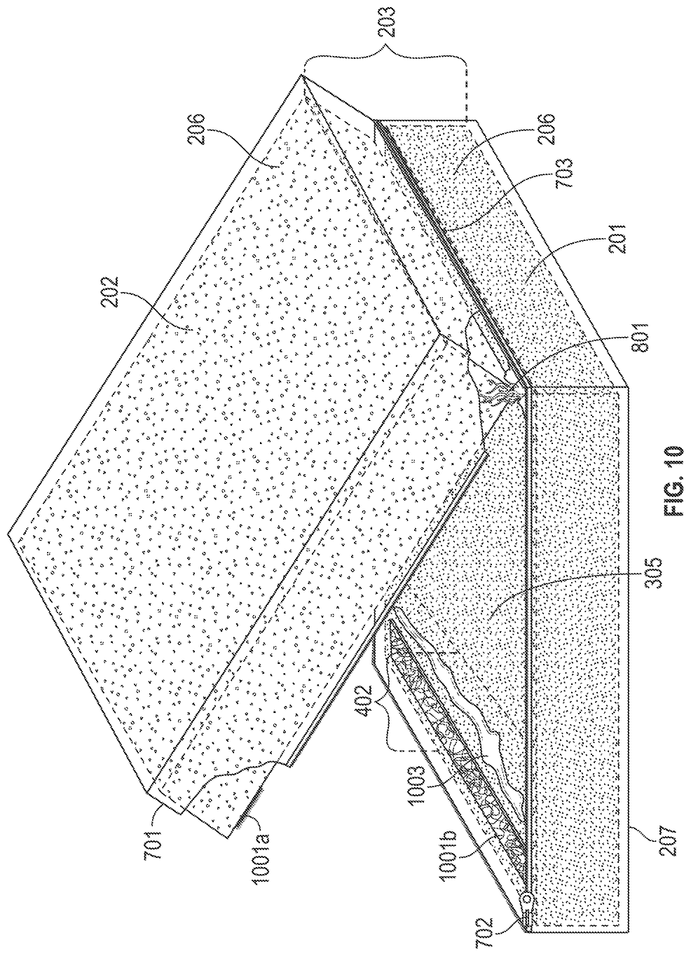

FIG. 10 illustrates an embodiment where at least one surface end 402 of the hard layer 201 is secured to at least one surface end 402 of the soft layer 202 utilizing a combination of previously mentioned securing methods. In this embodiment the loops 1001b on one or more surface ends 402 of the hard layer 201 may be secured to hooks 1001a on one or more surface ends 402 of the soft layer 202. Additionally, one or more of the surface ends 402 of the hard layer 201 may be secured to one or more surface ends 402 of the soft layer 202 by a surface end adhesive 1003 adjacent a section of hooks 1001a and loops 1001b. Furthermore, the individual layers 206 may also be secured by a singed bond 801 between outside corners 804 or surface corners 304 of the individual layers 206, Additionally, a wrapper 701 may be used to contain the plurality of core layers 203 therein. The wrapper 701 and plurality of core layers 203 may be contained within the mattress casing 204, which may form the mattress exterior.

The combination of securing methods may be applied to a single surface end 402 of the individual layers 206 or a plurality of surface ends 402 of the individual layers 206 either longitudinally, latitudinally, both, or in combination. Furthermore, the combination of securing methods may include utilizing surface corners 304 in addition to the surface ends 402. By way of non-limiting example, one embodiment may include utilizing corner adhesive 303 at one surface end 402 and utilizing segmented hooks 1001a and loops 1001b at either surface corners 304 or the entire length of another surface end 402. Likewise, the corner adhesive 303 at one or more surface ends 402 may be used in combination with surface end adhesive 603, 403. Another embodiment may include utilizing corner adhesive 303 at one or more surface corners 304 in combination with a singed bond 801 at one or more surface corners 304 or outside corners 804. Yet another embodiment may include using at least one of surface end adhesive 603, 403, corner adhesive 303, perimeter adhesive, singed bond 801, and corner patch with or without the wrapper 701. The latter embodiment may include securing individual layers 206 at one or more surface corners 304 or outside corners 804 in combination with one or more surface ends 402.

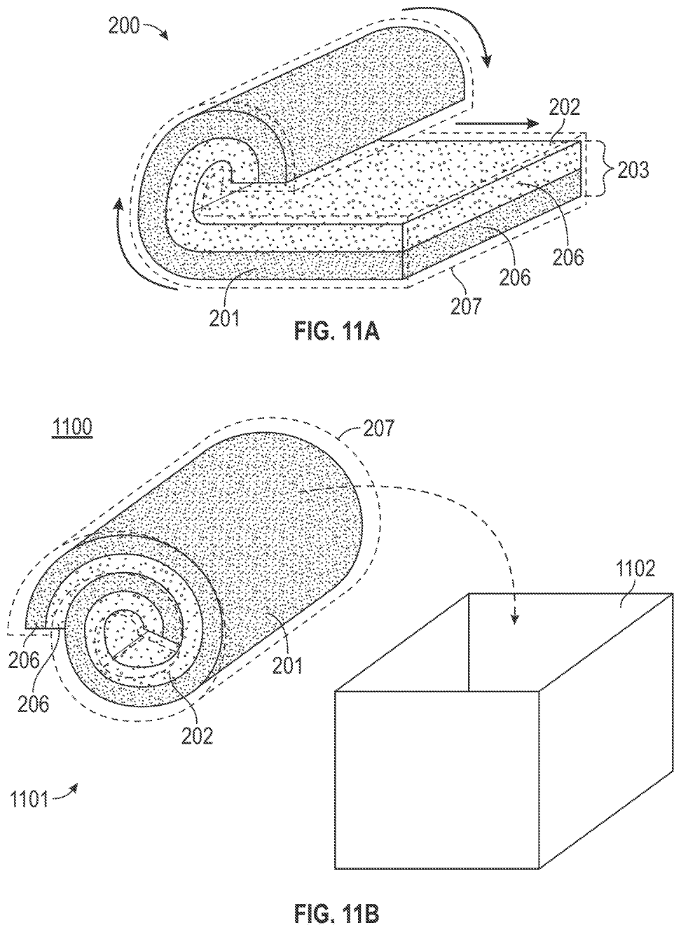

FIGS. 11a and 11b illustrate a shipping mattress 200 and a mattress shipping kit 1100. As described above, the shipping mattress 200 may be constructed by securing individual layers 206 within a plurality of core layers 203 to each other by attaching at least one of the surface corners 304, the surface ends 402, and the surface perimeters and leaving the bare surface area 305 unsecured. As FIG. 11a illustrates, once the individual layers 206 are secured, the shipping mattress 200 may be compressed by rolling the soft layers 202 inside the hard layers 201. The compressed mattress 1101 may then fit inside a box 1102 for shipping. Because the individual layers 206 of the shipping mattress 200 have been secured by at least one of surface ends 402, surface corners 304, surface perimeter, or wrapper 701 and not attached at the bare surface area 405, and because the shipping mattress 200 may be rolled with the soft layers 202 inside the hard layers 201, the shipping mattress 200 may be unpackaged and unrolled without shipping creases 102 on the mattress exterior. The mattress shipping kit 1100 may, for example, also include indicia positioned on the box, as well as instructions positioned within the box, and any tools that may be used to open the mattress wrapper 701.

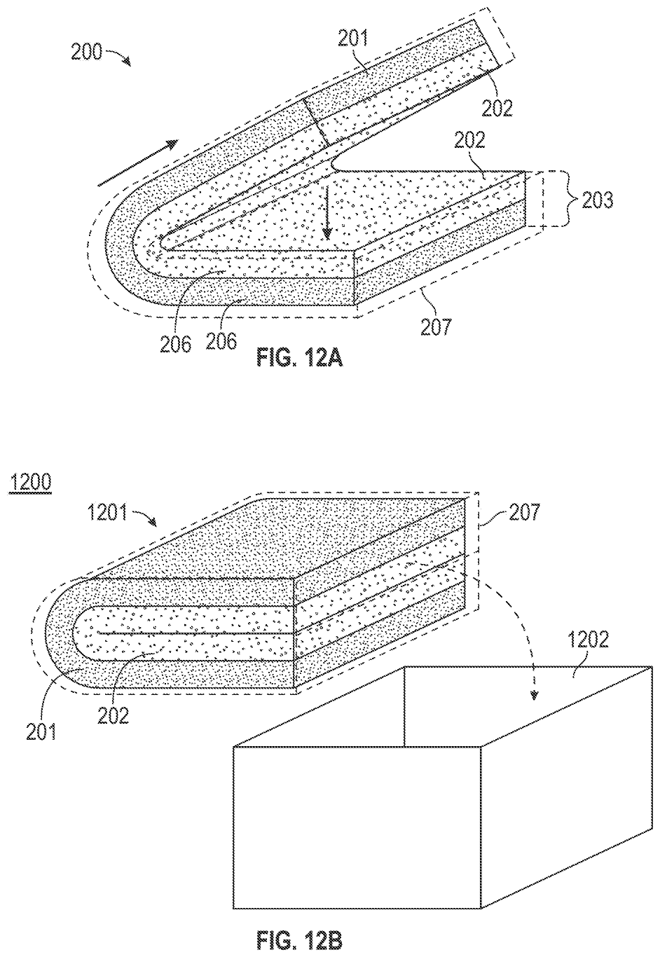

FIGS. 12a and 12b illustrate a mattress shipping kit 1200 as well as a method of manufacturing and transporting the shipping mattress 200. As described above, the shipping mattress 200 may be constructed by securing individual layers 206 within a plurality of core layers 203 to each other by attaching at least one of the surface corners 304, the surface ends 402, and the surface perimeters and leaving the bare surface area 305 unsecured. As FIG. 12a illustrates, once the individual layers 206 are secured, the shipping mattress 200 may be compressed by folding the soft layers 202 inside the hard layers 201. The compressed mattress 1201 may then fit inside a box 1202 for shipping. By way of non-limiting example, FIGS. 12A and 12B depict the shipping mattress 200 being folded in half. However, those skilled in the art will appreciate that the shipping mattress 200 may be folded in thirds, quarters or any other division enabling it to fit within the box 1202, so long as the soft layers 202 are folded inside the hard layers 201. Because the shipping mattress 200 individual layers 206 have been secured by at least one of its surface ends 402, surface corners 304, surface perimeter, or wrapper 701 and not attached at the bare surface area 405, and because the shipping mattress 200 may be folded with the soft layers 202 inside the hard layers 201, the shipping mattress 200 may be unpackaged and unfolded without shipping creases 102 on the mattress exterior.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof, Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus, the scope of the invention should be determined by the appended claims and their legal equivalents, and not by the examples given.

1. A shipping mattress configured to resist shipping creases comprising:
a plurality of core layers comprising stacked individual layers;
wherein the individual layers each comprise at least one surface;
wherein each surface comprises at least one surface corner and one surface end; and
wherein at least one of the surface corner and surface end of each individual layer is secured to at least one of the surface corner and surface end of another individual layer.

2. The shipping mattress according to claim 1 wherein each individual layer includes a density; wherein the plurality of core layers is defined by a first stacked end and a second stacked end; and wherein the density of the individual layer at the first stacked end is higher than the density of the individual layer at the second stacked end.

3. The shipping mattress of claim 1 wherein the plurality of core layers comprises a first individual layer and a second individual layer; and wherein the first individual layer has a higher density than the second individual layer.

4. The shipping mattress of claim 3 wherein the first individual layer is firmer than the second individual layer.

5. The shipping mattress of claim 1 wherein the surface corners of one individual layer are secured to the surface corners of another individual layer by an adhesive.

6. The shipping mattress of claim 1 wherein the surface corners of one individual layer are secured to the surface corners of another individual layer by a singed bond.

7. The shipping mattress of claim 6 wherein the singed bond is comprised of at least one of the surface corner material and a metallic matter attached to the surface corner material.

8. The shipping mattress of claim 7 wherein the metallic matter is one of aluminum and brass and the singed bond is configured as one of a radio frequency weld, a hot wedge weld, and hot air weld.

9. The shipping mattress of claim 1 wherein at least one surface of each individual layer comprises an adhesive applied along one of opposing longitudinal surface ends and latitudinal surface ends.

10. A shipping mattress configured to resist shipping creases comprising:
a plurality of core layers comprising stacked individual layers;
wherein the individual layers each comprise at least one surface circumscribed by surface edges;
wherein each surface comprises a surface perimeter defined by an area beginning at the surface edges and extending 12 inches distally toward a center portion of the surface;
wherein the stacked individual layers are secured to one another at the surface perimeter by symmetrically applied perimeter adhesive along the surface perimeter; and
wherein the perimeter adhesive is one of anaerobic, cyanoacrylate, toughened acrylic, epoxy, polyurethane, silicone, phenolic, polyimide, hot melt, plastisol, and polyvinyl acetate.

11. The shipping mattress according to claim 10 wherein at least one individual layer within the plurality of core layers is secured to another individual layer by a singed bond at the surface edges.

12. The shipping mattress according to claim 10 wherein each individual layer includes a surface end; and wherein at least one individual layer's surface end is further secured to another individual layer's surface end by a series of hooks on one individual layer surface end interlocking with a series of loops on the other individual layer's surface end.

13. The shipping mattress according to claim 10 wherein each individual layer within the plurality of core layers is further secured within a wrapper.

14. The shipping mattress according to claim 13 wherein the wrapper is further secured within a mattress casing.

15. A shipping mattress kit configured to resist shipping creases comprising:
a box sized to accommodate at least one of a rolled mattress and folded mattress;
a mattress comprising
a plurality of core layers comprised of stacked individual layers;
a wrapper configured to encapsulate the plurality of core layers; and
a mattress casing configured to encapsulate the wrapper;
wherein each individual layer ranges from a higher density individual layer at a first stacked end of the plurality of core layers to a lower density individual layer at a second stacked end of the plurality of core layers;
wherein the individual layers comprise surface area with corresponding surface ends and surface corners;
wherein at least one of the surface ends and surface corners of each individual layer are secured to adjacent surface ends and surface corners of another of the individual layers while leaving unsecured surface area between each individual layer and the other individual layer;
wherein the mattress is configured to fit inside the box when the mattress is one of rolled and folded, defined as a compressed mattress; and
wherein the compressed mattress is configured with lower density individual layers forming the inside of the compressed mattress and higher density individual layers forming the outside of the compressed mattress.

16. The shipping mattress kit according to claim 15 wherein the surface ends between individual layers are secured to each other by at least one of adhesive, a series of hooks and loops, and a singed bond.

17. The shipping mattress kit according to claim 15 wherein at least one surface of each individual layer within the plurality of core layers is secured at a surface corner to at least one surface corner of another individual layer.

18. The shipping mattress kit according to claim 17 wherein at least one individual layer's surface corner is secured to another individual layer's surface corner by singed bond.

19. The shipping mattress kit according to claim 17 wherein at least one individual layer's surface corner is secured to another individual layer's surface corner by adhesive.

20. The shipping mattress kit according to claim 17 wherein at least one individual layer's surface corner is secured to another individual layer's surface corner by a segment of hooks on one individual layer's surface corner and a segment of loops on another individual layer's surface corner.
